(19) United States
(12) Patent Application Publication
(10) Pub. No.: US 2014/0117879 A1
(43) Pub. Date: May 1, 2014

(54) ENERGY SAVING MOUSE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: SONG MA, Shenzhen (CN)

(21) Appl. No.: 13/927,149

(22) Filed: Jun. 26, 2013

(30) Foreign Application Priority Data
Oct. 31, 2012 (CN) 2012104270725

(51) Int. Cl. H05B 33/08

(52) U.S. Cl. CPC H05B 33/0845
USPC 315/307

(57) ABSTRACT

A energy saving mouse includes a switch module, a sensing module, a light-emitting diode, a control module, and a detection circuit. The sensing module and the detecting circuit output corresponding signals to the control module according to whether the energy saving mouse is in use or not in use. The control module controls the switch module to selectively supply power to the sensing module or to the light-emitting diode and the detection circuit.

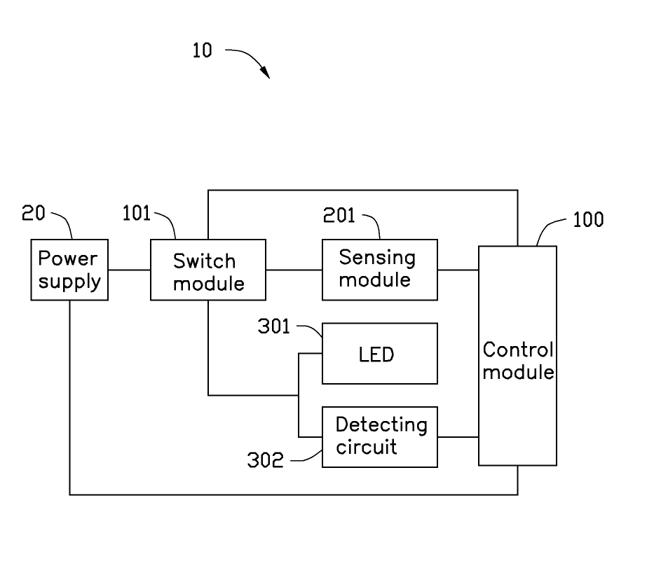

### BACKGROUND

1. Technical Field

The present disclosure relates to a energy saving mouse.

2. Description of Related Art

A light-emitting diode of a energy saving mouse will still operate even when a user stops using the energy saving mouse, which is a waste of energy.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The figure is a block diagram of an embodiment of a energy saving mouse of the present disclosure.

### DETAILED DESCRIPTION

The figure shows an embodiment of a energy saving mouse of the present disclosure. The energy saving mouse 10 includes a power supply 20, a control module 100, a switch module 101, a sensing module 201, a light-emitting diode (LED) 301, and a detecting circuit 302. Additionally, the energy saving mouse 10 also includes ordinary elements, such as light sensors, which will not be described in detail.

The switch module 101 includes a power input end, a control end, a first output end, and a second output end. The control end is connected to the control module 100. The detecting circuit 302 and the LED 301 are both connected to the first output end. The sensing module 201 is connected to the second output end.

The power supply 20 is connected to the control module 100 and the power input end, to supply power.

The sensing module 201 and the detecting circuit 302 are used to detect whether the energy saving mouse 10 is in use. When the power supply 20 starts operating the detecting 302 works and outputs different detection signals to the control module 100 depending on whether the energy saving mouse 10 is in use or not in use. When the energy saving mouse 10 is not in use, the detecting circuit 302 is turned off and the sensing module 201 is turned on to work. The sensing module 201 output different detection signals to the control module 100 depending on whether the energy saving mouse 10 is in use or not in use. When the energy saving mouse 10 is in use, the detecting circuit 302 is turned on and the sensing module 201 is turned off. The control module 100 outputs corresponding control signals based on the detection signals to the switch module 101. The switch module 101 connects the power supply 20 to either the first output end or the second output end.

Operations that indicate the energy saving mouse is in use may include sliding movement of the energy saving mouse 10 and pressing of buttons of the energy saving mouse 10. Initially, the control module 100 controls the switch module 101 to connect the first output end for the power supply 20 to supply power to the LED 301 and the detecting circuit 302 when the power supply 20 starts operating. The LED 301 and the detecting circuit 302 start operating and the sensing module 201 is electronically disconnected from the power supply 20. If, at that moment, there is any operation on the energy saving mouse 10, the operation will be detected by the detecting circuit 302, and the detecting circuit 302 outputs a first detection signal to the control module 100. The control module 100 outputs a first control signal to control the switch module 101 to maintain the connection between the power supply 20 and the first output end. If, at that moment, the detecting circuit 302 does not detect any operation on the energy saving mouse 10, the detecting circuit 302 outputs a second detection signal to the control module 100 indicating the energy saving mouse 10 is no longer in use. The control module 100 outputs a second control signal to the switch module 101 to control the switch module 101 to switch power from the first output to the second output end, thus turning off the LED 301 and detecting circuit 302, and turning on the sensing module 201 . The LED 301 and the detecting circuit 302 thus do not consume unneeded energy when the energy saving mouse 10 is not in use.

As long as the sensing module 201 does not sense any operation on the energy saving mouse 10, the sensing module 201 continuously outputs a third detection signal to the control module 100 indicating continued non-use of the energy saving mouse 10. The control module 100 outputs a third control signal to control the switch module 101 to maintain connection of the power supply 20 to the second output end. If at any time the sensing module 201 senses an operation on the energy saving mouse 10, the sensing module 201 outputs a fourth detecting signal to the control module 100 indicating the energy saving mouse 10 is once again in use. The control module 100 outputs a fourth control signal to control the switch module 101 to switch power from the second output end to the first output end thus turning the LED 301 and the detecting circuit 302 back to operate as described above.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A energy saving mouse, comprising:
a switch module comprising a power input end, a control end, a first output end, and a second output end, wherein the power input end is connected to a power supply;
a light-emitting diode connected to the first output end of the switch module;
a detecting circuit connected to the first output end of the switch module to detect whether the energy saving mouse is in use and output corresponding detection signals;
a sensing module connected to the second output end of the switch module to detect whether the energy saving mouse is in use and output corresponding detection signals; and
a control module connected to the detecting circuit and the sensing module to receive the detection signals from the detecting circuit or the sensing module, wherein the control module is connected to the control end of the switch module to output corresponding control signals based on the detection signals from the detecting circuit or the sensing module to control the switch module to connect the power supply to either the first output end or the second output end.

2. The energy saving mouse of claim 1, wherein the detecting circuit outputs a first detection signal to the control module when the detection circuit detects that there is an operation on the energy saving mouse, and the control module outputs a first control signal to control the switch module to connect the first output end for the power supply to supply power to the light-emitting diode and the detecting circuit; wherein when detecting there is no operation on the energy saving mouse, the detecting circuit outputs a second detection signal to the control module and then the control module outputs a second control signal to the switch module to control the switch module to connect the power supply to the second output end and disconnect the connection between the power supply and the first output end.

3. The energy saving mouse of claim 2, wherein the sensing module outputs a third detection signal to the control module when the control module detects that there is operation on the energy saving mouse, and the control module outputs a third control signal to control the switch module to connect the power supply to the first output end and disconnect the connection between the power supply and the second output end; wherein when detecting there is no operation on the energy saving mouse, the sensing module outputs a fourth detection signal to the control module and then the control module outputs a fourth control signal to the switch module to control the switch module to continue connecting the power supply to the second output end.
